(19) United States
(12) Patent Application Publication
(10) Pub. No.: US 2011/0115168 A1
(43) Pub. Date: May 19, 2011

(54) Seal With Snap-In Back-Up Ring

(75) Inventors: David D. Miller, Everly, IA (US); Raymond P. Hartzell, Perrysburg, OH (US)

(73) Assignee: FREUDENBERG-NOK GENERAL PARTNERSHIP, Plymouth, MI (US)

(21) Appl. No.: 12/706,832

(22) Filed: Feb. 17, 2010

Related U.S. Application Data
(60) Provisional application No. 61/262,739, filed on Nov. 19, 2009.

(51) Int. Cl. F16J 15/32

(52) U.S. Cl. 277/562

(57) ABSTRACT

A seal for a reciprocating rod includes an annular body having inner and outer seal lips extending axially from the annular body. The annular body includes a recess including a generally radially extending wall portion and a chamfered axially extending wall surface that is angled relative to a central axis of the annular body. A back-up ring is provided with an angled mating surface such that the backup ring is snap-fit in the recess of the annular body.

### CROSS-REFERENCE TO RELATED APPLICATIONS

This application claims the benefit of U.S. Provisional Application No. 61/262,739, filed on Nov. 19, 2009. The entire disclosures of the above application is incorporated herein by reference.

### FIELD

The present disclosure relates to a seal, and more particularly, to a seal with a snap-in back-up ring.

### BACKGROUND

This section provides background information related to the present disclosure which is not necessarily prior art.

As illustrated in FIG. 3, a cross-sectional view of a known seal is provided. The seal 100 includes an annular body 102 having a first angularly disposed radially inwardly extending seal lip portion 104 extending axially from the seal body 102 and an angularly disposed radially outwardly extending seal lip portion 106 extending axially from the annular body 102. The annular body 102 includes an angled outer edge surface 108 generally angled at approximately 45 degrees relative to an axis of the annular body 102. The annular body 102 is made from a urethane material. A nylon back-up ring 110 having a triangular cross-section, as illustrated in FIG. 4, has an inner angular surface 112 which is glued to the angled surface 108 of the annular body 102. The back-up ring 110 is secured to the annular body 102 by a gluing process that can be unreliable.

### SUMMARY

This section provides a general summary of the disclosure, and is not a comprehensive disclosure of its full scope or all of its features.

The present disclosure provides a positive snap-in back-up ring that is secured to a polyurethane seal by a snap-in feature, eliminating the need for an unreliable gluing operation.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is an exploded cross-sectional view of a seal with a snap-in back-up ring, according to the principles of the present disclosure;

FIG. 2 is a cross-sectional view showing the seal of the present disclosure with the back-up rings in an assembled condition;

FIG. 3 is a cross-sectional view of a prior art seal adapted for receiving a glued on back-up ring;

FIG. 4 is a cross-sectional view of a triangular shaped back-up ring according to the prior art;

FIG. 5 is a cross-sectional view of the present disclosure assembled in a housing and engaging a reciprocating rod; and

FIG. 6 is a cross-sectional view of the present disclosure assembled in a reciprocating rod and engaging an external housing.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

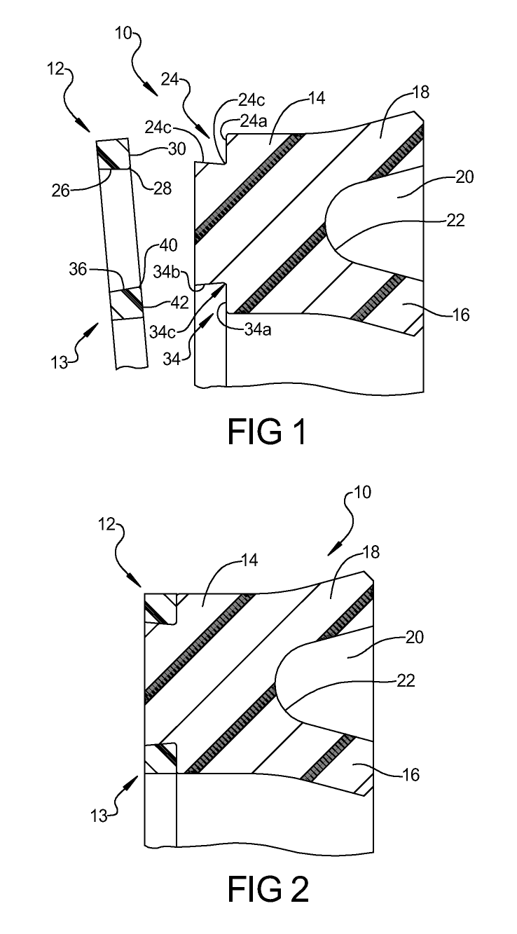

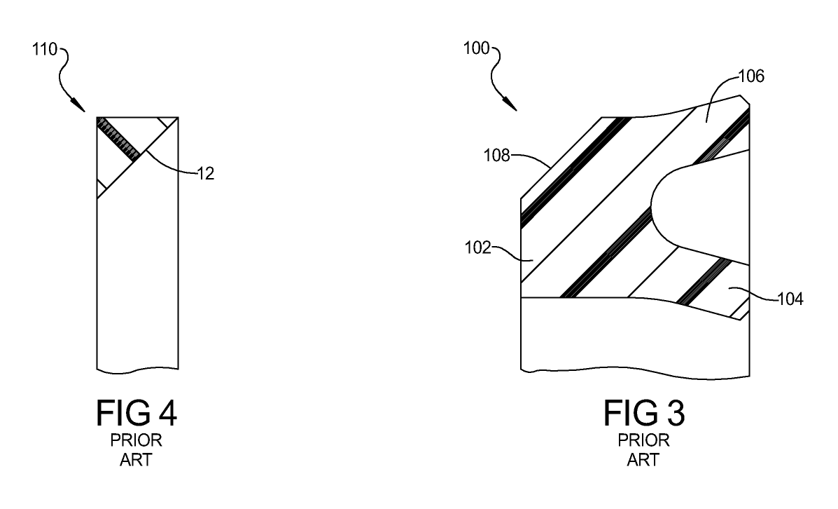

FIG. 1 is an exploded cross-sectional view showing a urethane seal 10 having an outer snap-in back-up ring 12 and an inner snap-in back-up ring 13 that are secured to the urethane seal ring 10 by a snap-in connection. The back-up rings 12, 13 can be made from nylon or other material. Back-up ring materials are chosen based on application requirements with special focus on maximum tensile strength, elongation, deflection temperature, extrusion resistance, fluid compatibility, and friction characteristics. The seal ring 10 can be made from urethane or other common sealing materials and includes an annular body 14 that includes an angled radially inwardly extending and axially extending seal lip 16 and an angled radially outwardly extending and axially extending seal lip 18. The seal lips 16, 18 each extend in the same axial direction. An annular groove 20 is disposed between the inner and outer lips 16, 18 and has a radiused axial face 22.

The body portion 14 has a generally rectangular cross-section with an outer recess 24 in an outer diameter thereof. Outer recess 24 can include a generally radially extending wall portion 24a and a chamfered axially extending radially outwardly facing wall surface 24b that is angled relative to a central axis of the annular seal 10. The angle of the chamfered wall surface 24b matches an inside diameter surface 26 of the back-up ring 12 so that the back-up ring 12 can be snap-fit in the recess 24 without requiring an unreliable gluing process. The chamfered surface 24b of the urethane seal 10 and the inner angled surface 26 of the back-up ring 12 are slightly angled relative to the center axis of the seal ring 10 with a sufficient angle to allow the back-up ring 12 to be retained onto the seal ring 10, as illustrated in FIG. 2. A radius 24c can be provided at the intersection of the radially extending wall portion 24a and the chamfered surface 24b to reduce stress points in the seal to help resist extrusion and tearing of the seal at high pressure. The backup ring 12 can also include a radiused surface 28 between the inner angled surface 26 and an axial face 30 that is complementary to the radius 24c.

The body portion 14 can include an inner recess 34 in an inner diameter thereof. Recess 34 can include a generally radially extending wall portion 34a and a chamfered axially extending radially inwardly facing wall surface 34b that is angled relative to an axis of the annular seal 10. The angle of the chamfered wall surface 34b matches an outer diameter surface 36 of the back-up ring 13 so that the back-up ring 13 can be snap-fit in the recess 34 without requiring an unreliable gluing process. The chamfered surface 34b of the urethane seal 10 and the inner angled surface 36 of the back-up ring 13 are slightly angled relative to the center axis of the seal ring 10 with a sufficient angle to allow the back-up ring 13 to be retained onto the seal ring 10, as illustrated in FIG. 2. A radius 34c can be provided at the intersection of the radially extending wall portion 34a and the chamfered surface 34b to reduce stress points in the seal to help resist extrusion and tearing of the seal at high pressure. The inner backup ring 13 can also include a radiused surface 40 between the angled surface 36 and an axial face 42 that is complementary to the radius 34c. It should be understood that the seal 10 can be provided with just one or both of the outer and inner back-up rings 12, 13.

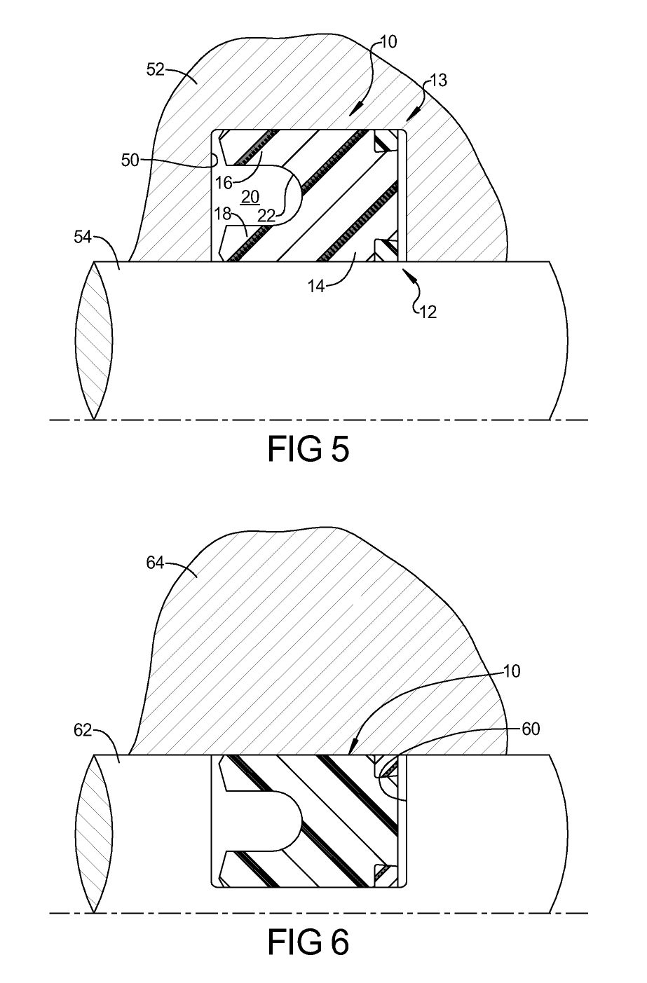

FIG. 5 illustrates the seal 10 disposed in an annular recess 50 in a housing 52 and having the inner surface engaging a reciprocating rod 54.

FIG. 6 illustrates the seal 10 disposed in an annular recess 60 in a reciprocating rod 62 and having an outer surface engaging a cylindrical housing 64.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A seal comprising:
an annular body;
an inner seal lip extending radially inwardly and axially from said annular body;
an outer seal lip extending radially outwardly and axially from said annular body;
said annular body defining an outer recess in an outer surface and including a generally radially extending wall portion and a chamfered axially extending radially outwardly facing wall surface that is angled relative to a central axis of the annular body; and
an outer backup ring having an inside diameter surface that is angled relative to a central axis of the outer backup ring such that the outer backup ring is snap-fit in the outer recess of said annular body.

2. The seal according to claim 1, wherein said annular body defines an inner recess in an inner surface and including a generally radially extending wall portion and a chamfered axially extending radially inwardly facing wall surface that is angled relative to a central axis of the annular body and an inner backup ring having an outside diameter surface that is angled relative to a central axis of said inner backup ring such that the inner backup ring is snap-fit in the inner recess of said annular body.

3. The seal according to claim 1, wherein said annular body is made from urethane and said outer backup ring is made from nylon.

4. The seal according to claim 2, wherein said annular body is made from urethane and said outer and inner backup rings are made from nylon.

5. A seal comprising:
an annular body;
an inner seal lip extending radially inwardly and axially from said annular body;
an outer seal lip extending radially outwardly and axially from said annular body;
said annular body defining an inner recess in an inner surface and including a generally radially extending wall portion and a chamfered axially extending radially inwardly facing wall surface that is angled relative to a central axis of the annular body; and
an inner backup ring having an outside diameter surface that is angled relative to a central axis of said inner backup ring such that the inner backup ring is snap-fit in the inner recess of said annular body.

6. The seal according to claim 5, wherein said annular body is made from urethane and said inner backup ring is made from nylon.
